(19) United States
(12) Patent Application Publication
(10) Pub. No.: US 2023/0398797 A1
(43) Pub. Date: Dec. 14, 2023

(54) RECORDING APPARATUS

(71) Applicant: CANON KABUSHIKI KAISHA, Tokyo (JP)

(72) Inventors: SEIJI SUZUKI, Kanagawa (JP); RAN KUDO, Tokyo (JP); TAKAYA SATO, Tokyo (JP); RYOSUKE ARAKI, Kanagawa (JP); TAKUYA HANE, Kanagawa (JP); TAKAYUKI OKAMOTO, Kanagawa (JP); SATOSHI KIMURA, Kanagawa (JP); SHINGO OKUSHIMA, Kanagawa (JP)

(21) Appl. No.: 18/329,664

(22) Filed: Jun. 6, 2023

(30) Foreign Application Priority Data
Jun. 14, 2022 (JP) 2022-095567

(51) Int. Cl. B41J 25/00; B41J 2/01

(52) U.S. Cl. CPC B41J 25/001; B41J 2/01

(57) ABSTRACT

In a recording apparatus including a recording head having an ejection port surface in which an ejection port that ejects a liquid is provided and a supporting portion configured to support the recording head to move the recording head between a recording position and a non-recording position, the supporting portion can be in a first state where an angle change of the ejection port surface is regulated and a second state where the angle change of the ejection port surface is not regulated.

### BACKGROUND OF THE INVENTION

### Field of the Invention

The present invention relates to a recording apparatus that ejects a liquid onto a recording material to perform recording.

### Description of the Related Art

There has conventionally been known a recording apparatus that ejects drops of a recording liquid such as ink onto a recording material such as recording paper or a resin sheet to record characters, images, or the like. Such a recording apparatus may be configured so as to perform recording on a recording material conveyed in a direction inclined with respect to a horizontal direction. To record high-quality characters or images with high accuracy onto the recording material conveyed in a direction thus inclined, it is necessary to position an orientation of an ejection port surface of a recording head with high accuracy such that a direction in which the ink is ejected is perpendicular to a recording surface of the recording material. Japanese Patent Application Publication No. 2020-011522 discloses a technology in which, in positioning of a recording head, using a mechanism of simultaneously progressing linear movement and rotational movement of the recording head, the recording head is positioned at a predetermined angle with respect to a horizontal direction at a printing position.

### SUMMARY OF THE INVENTION

The guide mechanism disclosed in Japanese Patent Application Publication No. 2020-011522 is configured such that a trajectory of the linear movement of the recording head is determined by a trajectory of extension of a guide hole and that a direction in which the guide hole extends is determined according to the positioning angle of the recording head at a recording position. In a recording apparatus in which, e.g., a conveyance path for a recording material curvedly extends, and a plurality of recording heads are arranged side by side along the conveyance path, the positioning angles of the individual recording heads need to be set different. In the case of using the guide mechanism disclosed in Japanese Patent Application Publication No. 2020-011522 for such a recording apparatus, a need arises to individually prepare the guide mechanisms in which the guide holes have different shapes corresponding to the respective positioning angles of the individual recording heads on a per recording-head basis. Therefore, there are concerns about complication of the guide mechanisms, increases in apparatus size and cost, and the like.

An object of the present invention is to provide a highly versatile guide mechanism capable of positioning a recording head at any angle.

To attain the foregoing object, the recording apparatus of the present invention includes:
a recording head having an ejection port surface in which an ejection port that ejects a liquid is provided; and
a supporting portion configured to support the recording head to move the recording head between a recording position where recording is performed and a non-recording position where the recording is not performed,
wherein the supporting portion can be in a first state where an angle change of the ejection port surface is regulated and a second state where the angle change of the ejection port surface is not regulated.

According to the present invention, it is possible to provide a highly versatile guide mechanism capable of positioning a recording head at any angle.

Further features of the present invention will become apparent from the following description of exemplary embodiments with reference to the attached drawings.

### BRIEF DESCRIPTION OF THE DRAWINGS

FIG. 1 is a schematic diagram illustrating an inner configuration of a recording apparatus;

FIG. 2 is a control configuration diagram of the recording apparatus;

FIG. 3 is a diagram illustrating a sheet conveyance portion housing of a recording portion;

FIG. 4A is a top view of the sheet conveyance portion housing and FIG. 4B is a relationship diagram of a sheet, recording heads, and guide rollers;

FIG. 5 is a perspective view of a recording head up-down mechanism;

FIG. 6 is a perspective view of the recording head;

FIGS. 7A to 7D are illustrative views of an example of a recording head positioning operation;

FIGS. 8A to 8C are diagrams illustrating a retracted position of each of the recording heads;

FIGS. 9A to 9C are diagrams illustrating configurations of the recording head and biasing members;

FIGS. 10A to 10C are diagrams illustrating movement of the recording head;

FIGS. 11A to 11C are diagrams illustrating the movement of the recording head;

FIGS. 12A to 12C are diagrams illustrating the movement of the recording head;

FIGS. 13A to 13C are diagrams illustrating a printing position of the recording head;

FIGS. 14A and 14B are diagrams illustrating the configurations of the recording head and the biasing members;

FIGS. 15A to 15C are diagrams illustrating a retracting operation of the recording head; and

FIG. 16 is a diagram illustrating an inclined state of the recording head and electric connector connecting portions.

### DESCRIPTION OF THE EMBODIMENTS

Referring to the drawings, modes for carrying out this invention will be described below in detail by way of example on the basis of each of embodiments. Note that dimensions, materials, shapes, relative positioning, and the like of components described in the embodiment are to be appropriately changed depending on a configuration of an apparatus to which the present invention is applied and various conditions. In addition, not all of the combinations of features described in the present embodiment are indispensable to the means to solve the problems of the present invention. Note that the components described in the embodiment are merely examples, and are not intended to limit the scope of this invention only thereto.

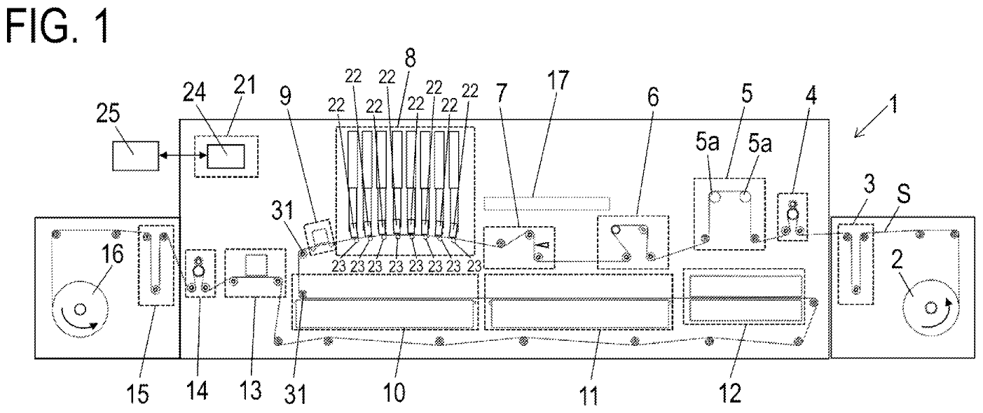

First, it is defined that a direction upward of an apparatus in FIG. 1 is an upward direction, a direction from the right to left of the figure is a longitudinal direction, a direction from the front to back of a paper surface perpendicular to a sheet conveyance direction is a sheet width direction, a front side of the paper surface is an apparatus front side, and a back side of the paper surface is an apparatus rear side. The recording apparatus 1 in the present embodiment is a high-speed line printer using a continuous sheet wound in a roll shape.

Recording Apparatus

FIG. 1 is a schematic cross-sectional view illustrating an inner configuration of a recording apparatus 1 according to the present embodiment. The recording apparatus 1 according to the present embodiment includes various units in the inside thereof. In other words, the recording apparatus 1 includes an unwinding roll portion 2, a first dancer portion 3, a first main conveyance portion 4, a meandering correction portion 5, a conveyance detection portion 6, a mark sensor portion 7, and a recording portion 8. Additionally, the recording apparatus 1 includes a first scanner portion 9, a first drying portion 10, a second drying portion 11, a cooling portion 12, a second scanner portion 13, a second main conveyance portion 14, a second dancer portion 15, a winding roll portion 16, and a maintenance portion 17. A sheet S serving as a recording material is conveyed along a sheet conveyance path indicated by a solid line in the figure to be processed in each of the units.

The unwinding roll portion 2 is a unit for holding and feeding the continuous sheet wound in the roll shape. The unwinding roll portion 2 is configured to contain an unwinding roll and pull out and feed the sheet S. Note that the number of containable rolls is not limited to one, and the configuration may also be such that two, three, or more rolls are contained, and the sheet S is alternatively pulled out and fed.

The first dancer portion 3 is a unit for providing a constant sheet tension between the unwinding roll portion 2 and the first main conveyance portion 4. To the first dancer portion 3, the sheet tension is imparted by a tension imparting unit not shown. The first main conveyance portion 4 is a unit for feeding the sheet S to the meandering correction portion 5, the conveyance detection portion 6, the mark sensor portion 7, the recording portion 8, the first scanner portion 9, the first drying portion 10, the second drying portion 11, the cooling portion 12, and the second scanner portion 13 which are arranged in this order along the sheet conveyance path (sheet S) and imparting the sheet tension between the first main conveyance portion 4 and the second main conveyance portion 14. The first main conveyance portion 4 is rotated by driving a motor not shown to perform conveyance of the sheet S under the tension.

The meandering correction portion 5 is a unit for correcting meandering in the sheet width direction during the conveyance of the sheet S under the tension. The meandering correction portion 5 is configured to include a meandering correction roller 5a and a meandering detecting sensor which detects meandering of the sheet S and is not shown. The meandering correction roller 5a is capable of changing an inclination of the sheet S by using the motor not shown, and corrects the meandering of the sheet S on the basis of measurement by the meandering detecting sensor. At this time, the sheet S is wound around the meandering correction roller 5a to be able to enhance a meandering correcting function.

The conveyance detection portion 6 is a unit for detecting the tension when the conveyance is performed the under tension between the first main conveyance portion 4 and the second main conveyance portion 14. The conveyance detection portion 6 is also a unit for detecting a speed of the sheet S in order to control image formation timing in the recording portion 8.

The mark sensor portion 7 is a unit for detecting a mark printed in advance on the sheet S in order to control the image formation timing in the recording portion 8.

The recording portion 8 is a sheet processing portion that ejects ink as a recording liquid from above onto the conveyed sheet S by using recording heads 22 to form an image or the like and thus perform recording processing on the sheet S. The conveyance path in the recording portion 8 is formed of guide rollers 23 arranged in an upwardly projected arc shape, and a constant tension is imparted to the sheet S to ensure a clearance with each of the recording heads 22. The plurality of recording heads 22 are arranged along a conveyance direction. The present embodiment has a total of eight line-type recording heads corresponding to a reactive solution and three spot color inks in addition to inks in four colors of Bk (black), Y (yellow), M (magenta), and C (cyan). Note that each of the number of the colors and the number of the recording heads 22 is not limited to 8. As an inkjet method, a method using heating elements, a method using piezoelectric elements, a method using electrostatic elements, a method using MEMS elements, or the like can be used. The inks in the different colors are fed from respective ink tanks not shown to the recording heads 22 via respective ink tubes.

The first scanner portion 9 is a unit for reading the image formed on the sheet S in the recording portion 8 during the printing, detecting a misalignment or concentration of the image, and correcting the printing.

The first drying portion 10 and the second drying portion 11 are units for reducing a liquid component included in each of the inks imparted onto the sheet S in the recording portion 8 and increasing fixing performance between the sheet S and the ink. The second drying portion 11 is disposed downstream of the first drying portion 10 in the sheet conveyance direction. The first drying portion 10 and the second drying portion 11 heat the recorded sheet S to dry the inks imparted thereto. In the first drying portion 10 and the second drying portion 11, a hot air current is imparted at least to an ink imparted surface (recording surface) side of the passing sheet S to dry the ink imparted surface of the sheet S. Note that a drying method may also be configured to include a combination of a method of irradiating a surface of the sheet S with an electromagnetic wave (such as an ultraviolet ray or an infrared ray) and a conduction heat transfer method based on contact with a heating element besides a method of imparting the hot air current.

Each of wrapped guide rollers 31 is a roller to be wrapped at a given wrapping angle with a surface of the sheet S downstream of the recording portion 8 in the conveyance direction which is opposite to the ink imparted surface due to the need to block the influence of the hot air current from the first drying portion 10 on the recording portion 8. In the present embodiment, the two wrapped guide rollers 31 are disposed between the first scanner portion 9 and the first drying portion 10, and the sheet S is folded back to be substantially parallel to each other in upper and lower parts of the apparatus. The first drying portion 10 is disposed below the recording portion 8 in the apparatus, while the second drying portion 11 is disposed below the conveyance detection portion 6 and the mark sensor portion 7 each described above in the apparatus.

The cooling portion 12 cools the sheet S subjected to fixation in the first drying portion 10 and the second drying portion 11 to solidify the softened inks and reduce an amount of a temperature change of the sheet S in a downstream step in the recording apparatus. In the cooling portion 12, an air current at a temperature lower than that of the sheet S is imparted at least to the ink imparted surface side of the sheet S passing therethrough to cool the ink imparted surface of the sheet S. Note that a cooling method is not limited to a method of imparting an air current, and may also be configured to include the conduction heat transfer method based on contact with a heating member or a combination thereof.

The second scanner portion 13 is a unit for reading a test image formed on the sheet S in the recording portion 8 before the printing and detecting the misalignment or concentration of the image to effect correction for real printing.

The second main conveyance portion 14 is a unit that conveys the sheet, while imparting the tension to each of the first main conveyance portion 4 and the sheet S, and adjusts the tension of the sheet S. The second main conveyance portion 14 has a clutch (not shown) which is rotated by being driven with the motor not shown, and a torque drivably connected to the clutch is controlled by a tension control portion not shown depending on a tension value detected by a tension detection portion (not shown) to adjust the tension of the sheet S. Note that, as an additional configuration that adjusts the tension of the sheet S, a configuration that controls a speed of the second main conveyance portion 14 by using the tension detection portion may also be added. In this case, a tension control method includes two methods which are a torque control method in which a torque value transmitted from the clutch is controlled and a speed control method in which a roller speed of the second main conveyance portion 14 is controlled, and the tension control method is switched therebetween depending on the purpose or, alternatively, the two methods can also be used simultaneously.

The second dancer portion 15 is a unit for imparting a constant sheet tension between the second main conveyance portion 14 and the winding roll portion 16. The second dancer portion 15 can impart the sheet tension with the tension imparting unit not shown.

The winding roll portion 16 is a unit for winding the sheet S subjected to the recording processing around a winding core. The number of collectable rolls is not limited to one, and the winding roll portion 16 may also be configured to have two, three, or more winding cores to collect the sheet S through alternative switching. Note that, depending on details of processing treatment after the recording, it may also be possible to use a configuration in which the continuous sheet is cut with a cutter, and the cut sheets S are stacked, not a configuration in which the sheet S is wound around the winding core.

The maintenance portion 17 is a unit including a mechanism of recovering ejection performance of the recording head 22. Examples of such a mechanism include a cap mechanism that covers ink ejection surfaces of the recording heads 22, a wiper mechanism that wipes the ink ejection surfaces, and a suction mechanism that sucks the inks in the recording heads 22 from the ink ejection surfaces under a negative pressure. The maintenance portion 17 includes a drive mechanism and a rail each not shown to be reciprocatable in a horizontal direction along the rail, and moves to immediately below the recording heads at the time of maintenance of the recording heads, while moving to a position retracted from immediately below the recording heads to an upstream side in the conveyance direction when a maintenance operation is not performed.

The control portion 21 is a unit in charge of control of each of the units of the entire recording apparatus. The control portion 21 has a controller including a CPU, a storage device, and various control portions, an external interface, and an operation portion 24 on which a user performs inputting/outputting. An operation of the recording apparatus 1 is controlled on the basis of an instruction from the controller or a host device 25 such as a host computer connected to the controller via the external interface.

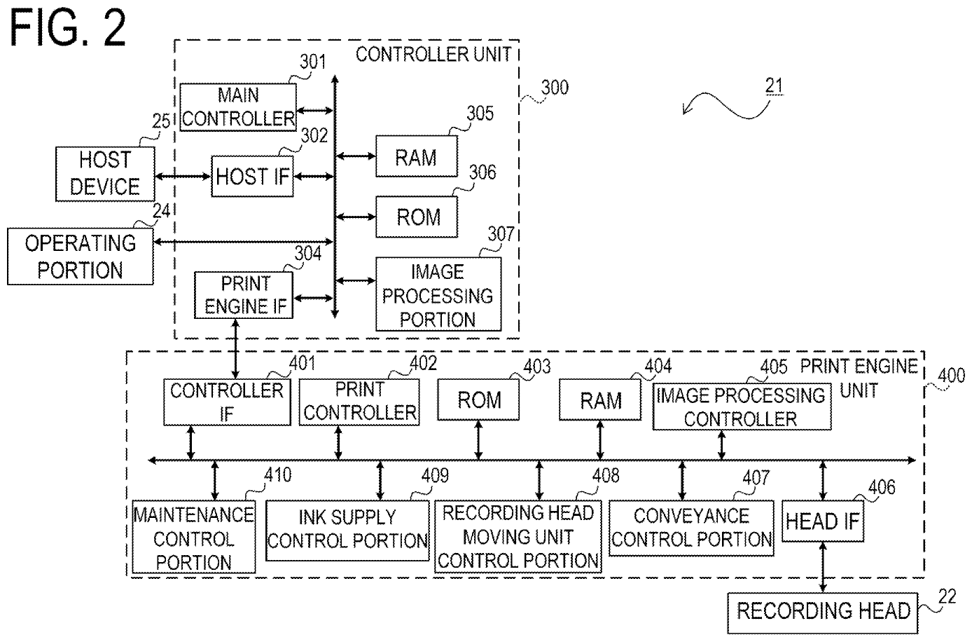

FIG. 2 is a block diagram illustrating a control configuration in the recording apparatus 1. The control configuration of the control portion 21 is mainly configured to include a print engine unit 400 that controls the recording apparatus 1 and a controller unit 300 that controls the entire recording apparatus 1. A print controller 402 follows an instruction from a main controller 301 of the controller unit 300 to control various mechanisms of the print engine unit 400. A description will be given below of details of the control configuration.

The main controller 301 configured to include the CPU in the controller unit 300 controls the entire recording apparatus 1, while using a RAM 305 as a work area, according to a program stored in a ROM 306 or various parameters. For example, when a printing job is input from the host device 25 via a host I/F 302, the main controller 301 follows the instruction from the main controller 301 to perform predetermined image processing on image data received by an image processing portion 307. Then, the main controller 301 transmits, via a print engine I/F 304, the image data on which the image processing has been performed to the print engine unit 400.

Note that the recording apparatus 1 may also acquire the image data from the host device 25 via wireless communication or wired communication, or may also acquire the image data from an external storage device (such as a USB memory) connected to the recording apparatus 1. Communication methods to be used for the wireless communication or wired communication are not limited. For example, to the communication method to be used for the wireless communication, Wireless Fidelity (Wi-Fi) (registered trademark) or Bluetooth (registered trademark) is applicable. Meanwhile, to the communication method to be used for the wired communication, Universal Serial Bus (USB) or the like is applicable.

The operation portion 24 is a mechanism for the user to perform inputting/outputting on the recording apparatus 1. The user can set a printing mode or recognize information from the recording apparatus 1 via the operation portion 24.

In the print engine unit 400, the print controller 402 configured to include the CPU controls the various mechanisms included in the recording apparatus 1, while using a RAM 404 as a work area, according to a program and various parameters each stored in a ROM 403. When various commands and the image data are received via a controller I/F 401, the print controller 402 temporarily stores the commands and image data in the RAM 404. The print controller 402 causes an image processing controller 405 to convert the stored image data to recorded data so as to allow the recording heads 22 to use the recorded data for recording operations. When the recorded data is generated, the print controller 402 causes the recording heads 22 to perform the recording operations based on the recorded data via a head I/F 406. At this time, the print controller 402 drives the various units illustrated in FIG. 1 via a conveyance control portion 407 to convey the sheet S. In other words, the print controller 402 drives the unwinding roll portion 2, the first dancer portion 3, the first main conveyance portion 4, the meandering correction portion 5, the conveyance detection portion 6, the mark sensor portion 7, the recording portion 8, the first scanner portion 9, the first drying portion 10, the second drying portion 11, the cooling portion 12, the second scanner portion 13, the second main conveyance portion 14, the second dancer portion 15, and the winding roll portion 16. According to an instruction from the print controller 402, the recording operations are performed by the recording heads 22 in conjunction with an operation of conveyance the sheet S, and printing processing is performed.

A recording head moving unit control portion 408 changes positions of the recording heads 22 depending on an operation state of the recording apparatus 1 such as a maintenance state or a recording state. An ink supply control portion 409 controls ink supply units (not shown) such that pressures of the inks supplied to the recording heads 22 fall within appropriate ranges. A maintenance control portion 410 controls an operation of the maintenance portion 17 when a maintenance operation is performed on the recording heads 22.

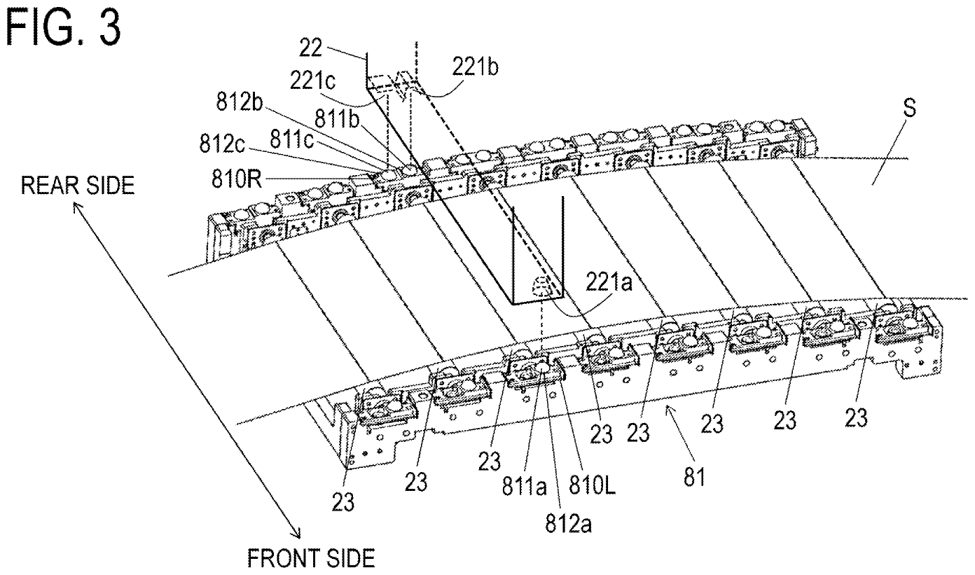

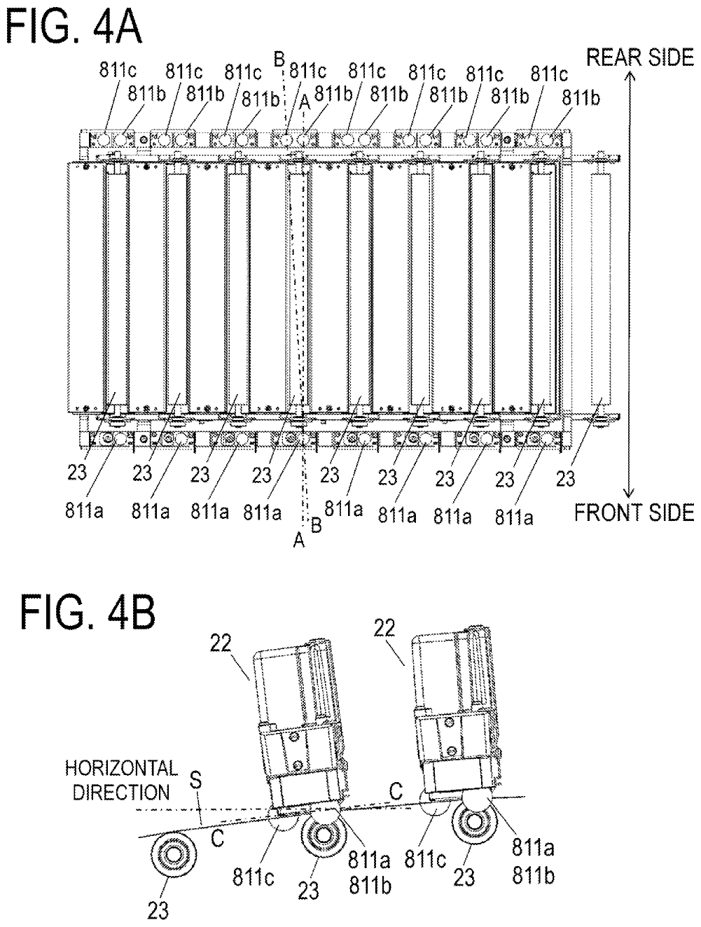

Sheet Conveyance Portion Housing FIG. 3 is a perspective view of a sheet conveyance portion housing 81 of the recording portion 8. FIG. 4A illustrates a diagram obtained by viewing the sheet conveyance portion housing 81 from a top surface of the apparatus, while FIG. 4B illustrates a diagram representing relationships among the sheet S, the recording heads 22, and the guide rollers 23. As illustrated in FIG. 3, in the sheet conveyance portion housing 81, a plurality of first positioning members 811a, a plurality of second positioning members 811b, and a plurality of third positioning members 811c each for performing positioning of the recording heads 22 at a printing position (recording position) are provided. For each one of the recording heads 22, the first positioning member 811a is provided on a front side (apparatus front side) of the sheet S in the sheet width direction perpendicular to the sheet conveyance direction, while the second positioning member 811b and the third positioning member 811c are provided on a back side (apparatus rear side) thereof.

The first positioning member 811a, the second positioning member 811b, and the third positioning member 811c are spherical members of equal diameters. The first positioning member 811a, the second positioning member 811b, and the third positioning member 811c are mounted by being fitted in depressed portions 812 provided in positioning/supporting portions 810 included in the sheet conveyance portion housing 81. The first positioning member 811a, the second positioning member 811b, and the third positioning member 811c have respective substantially lower (lower hemispherical) portions embedded in the depressed portions 812 and have respective substantially upper (upper hemispherical) portions exposed from the depressed portions 812 to form upwardly projecting substantially hemispherical positioning portions having protruded shapes. The positioning/supporting portions 810 include a front-side positioning/supporting portion 810L placed on a front side of the sheet conveyance path in the sheet width direction and a back-side positioning/supporting portion 810R placed on a back side thereof. The first positioning member 811a is mounted in a first depressed portion 812a provided in the front-side positioning/supporting portion 810L. The second positioning member 811b is mounted in a second depressed portion 812b provided in the back-side positioning/supporting portion 810R, while the third positioning member 811c is mounted in a third depressed portion 812c provided in the back-side positioning/supporting portion 810R. The second depressed portion 812b is provided on an upstream side of the third depressed portion 812c in the sheet conveyance direction.

As illustrated in FIG. 4A, the first positioning member 811a and the second positioning member 811b are placed such that a straight line A-A passing through each of a center of the first positioning member 811a and a center of the second positioning member 811b is parallel to a rotation axis of the guide roller 23. Meanwhile, as illustrated in FIGS. 4A and 4B, the third positioning member 811c is placed on a downstream side of the first positioning member 811a and the second positioning member 811b in the sheet conveyance direction. As illustrated in FIG. 4A, the third positioning member 811c is placed such that a straight line B-B passing through each of a center thereof and the center of the first positioning member 811a has a predetermined angle with respect to the straight line A-A passing through each of the center of the first positioning member 811a and the center of the second positioning member 811b. Additionally, as illustrated in FIG. 4B, the third positioning member 811c is placed such that a straight line C-C passing through each of the center thereof and the center of the first positioning member 811a or the second positioning member 811b has a predetermined angle with respect to the horizontal direction.

In other words, the third positioning member 811c is placed at a position lower than that of each of the first positioning member 811a and the second positioning member 811b (position away from the recording head 22) in an up-down movement direction between the retracted position of the recording head 22 and the printing position. Such placement of the third positioning member 811c with respect to the first positioning member 811a and the second positioning member 811b is set so as to allow nozzle plates (not shown) of the recording head 22 at the printing position to be positioned parallel to the sheet S supported by the plurality of guide rollers 23. In other words, the position at which the third positioning member 811c is located is set such that the recording head 22 at the printing position is positioned in an attitude inclined at a predetermined angle at a predetermined recording position. The predetermined angle mentioned herein is an angle at which nozzles (ejection ports) of the nozzle plates perpendicularly face the recording surface of the sheet S (a nozzle surface (ejection port surface) in which the nozzles are open is parallel to the recording surface). As described above, the first positioning member 811a, the second positioning member 811b, and the third positioning member 811c are spherical bodies of equal diameters, and the respective centers thereof are respective centers of the spherical bodies.

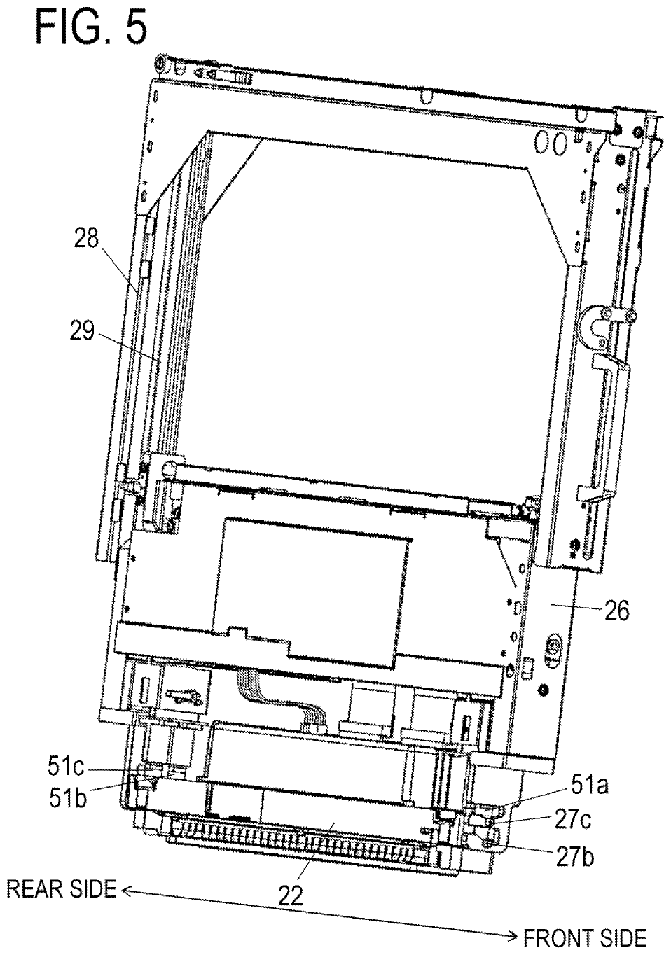

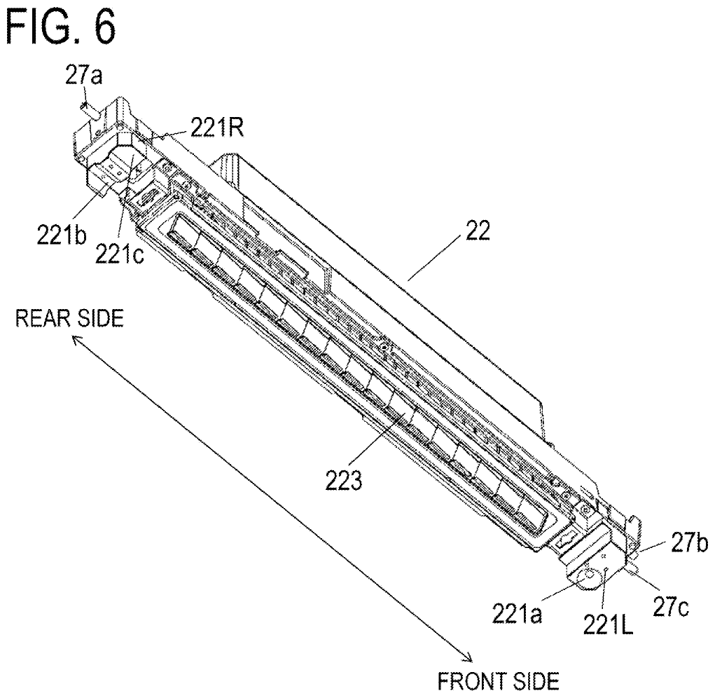

As illustrated in FIG. 5, each of the recording heads 22 is held by a head holder 26 serving as a supporting portion and configured to vertically move upward and downward with movement of the head holder 26. The recording head 22 is provided with a first pin 27a (see FIG. 6 and the like), a second pin 27b, and a third pin 27c. The first pin 27a is a projecting portion projecting in a width direction from one (on the apparatus front side) of both end portions of the recording head 22 in the longitudinal direction (width direction) of the recording head 22 crossing each of an up-down direction of the recording head 22 and the sheet conveyance direction. Each of the second pin 27b and the third pin 27c is a projecting portion projecting in the longitudinal direction from another end portion (on the apparatus rear side) of the recording head 22 in the longitudinal direction. The recording head 22 is axially supported with respect to the head holder 26 in a manner such that the first pin 27a, the second pin 27b, and the third pin 27c are respectively supported from below by a first hole 261, a second hole 262, and a third hole 263 each provided in the head holder 26.

In addition, the recording head 22 is supported by the head holder 26 while being biased downward by a first biasing member 51a, a second biasing member 51b, and a third biasing member 51c each provided on the head holder 26. Configurations of the first biasing member 51a, the second biasing member 51b, and the third biasing member 51c will be described later. The head holder 26 vertically performs an up-down operation along an up-down rail 29 provided in a recording head up-down frame 28 by using a drive mechanism provided in the inside thereof and not shown.

Configuration of Recording Head FIG. 6 is a perspective view of the recording head 22. As illustrated in FIG. 6, on the recording head 22, a plurality of nozzle plates 223 each including the plurality of nozzles (ejection ports) that eject the ink are arranged to be aligned in the recording head longitudinal direction (sheet width direction). At both ends of the recording head 22 in the longitudinal direction (direction perpendicular to the sheet conveyance direction), to-be-positioned portions 221L and 221R are provided. Specifically, the to-be-positioned portion 221L on the front side (apparatus front side) in the head longitudinal direction is provided with a first contact portion 221a made of a depressed shape portion including a conical inclined surface. Meanwhile, the to-be-positioned portion 221R on the back side (apparatus rear side) in the head longitudinal direction is provided with each of a second contact portion 221b made of a groove shape portion including two substantially V-shaped surfaces and extending in the head longitudinal direction and a third contact portion 221c formed of a planar portion, which are arranged in the sheet conveyance direction.

In the longitudinal direction of the recording head 22, a straight line passing through each of a center of the first contact portion 221a and a center of the second contact portion 221b is accurately located so as to be parallel to an arrangement of the plurality of nozzle plates 223 of the recording head 22. The respective centers of the first contact portion 221a and the second contact portion 221b are respective centers of virtual spherical bodies of equal diameters that are respectively inscribed therein. The third contact portion 221c is placed at a position away from the second contact portion 221b in the sheet conveyance direction (direction perpendicular to the longitudinal direction of the recording head 22).

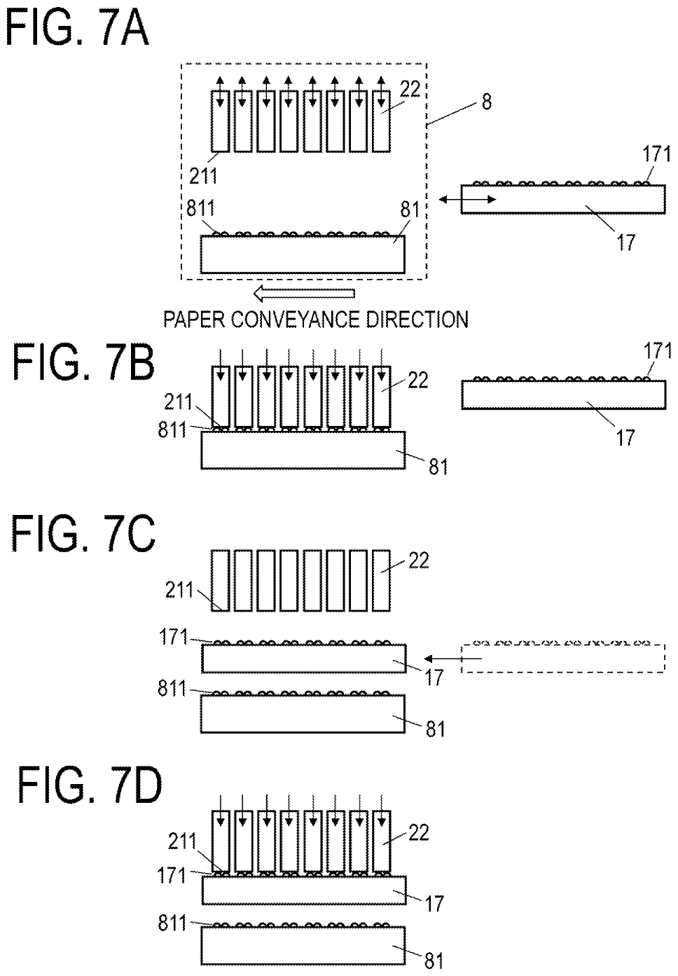

Operation of Recording Head Referring to FIGS. 7A to 7D, a description will be given of a positioning operation for the recording head 22 in the recording apparatus according to the present embodiment. FIGS. 7A to 7D are schematic illustrative views illustrating an example of an operation involving the positioning of the recording head 22.

FIG. 7A is the schematic diagram illustrating a state where the recording head 22 is at the retracted position upwardly retracted with respect to the sheet conveyance portion housing 81 as a non-recording position where recording is not performed, while the maintenance portion 17 is at a non-maintenance position substantially horizontally retracted from the recording head 22 in the sheet conveyance direction.

FIG. 7B is the schematic diagram illustrating a state where the recording head 22 is at the printing position where an image is recorded on the sheet S as the recording position where recording is performed. When the recording head 22 moves from the retracted position to the printing position, the recording head 22 is substantially perpendicularly moved downward by the recording head up-down mechanism described previously from the upper retracted position. The movement of the recording head 22 is completed by the to-be-positioned portions 221 by coming into contact with the positioning members 811 provided in the sheet conveyance portion housing 81 and by the recording head 22 by lowering to the printing position where the recording head 22 is positioned in an attitude in which an orientation thereof is inclined at the predetermined angle.

FIG. 7C is the schematic diagram illustrating a state where the recording head 22 is at the retracted position and the maintenance portion 17 has moved to a maintenance position. In such a case as where capping is performed on the recording head 22 after a printing operation or where the nozzles of the recording head 22 are clogged to result in an ink ejection failure, the maintenance operation is performed by the maintenance portion 17 on the recording head 22. In the case of performing the maintenance operation, first, the recording head 22 and the maintenance portion 17 each illustrated in FIG. 7A move to respective retracted positions. Then, the maintenance portion 17 substantially horizontally moves in the sheet conveyance direction, and moves to the maintenance position below the recording head 22.

FIG. 7D is the schematic diagram illustrating a state where the recording head 22 has moved to the maintenance position where the maintenance operation for the recording head 22 is to be performed by the maintenance portion 17. The recording head 22 substantially perpendicularly moves downward from the state in FIG. 7C, and the to-be-positioned portions 221 lower to the maintenance position where the to-be-positioned portions 221 come into contact with recording head positioning portions 171 provided in the maintenance portion 17 to be positioned. In this state, various maintenance operations are performed by the maintenance portion 17 on the recording head 22.

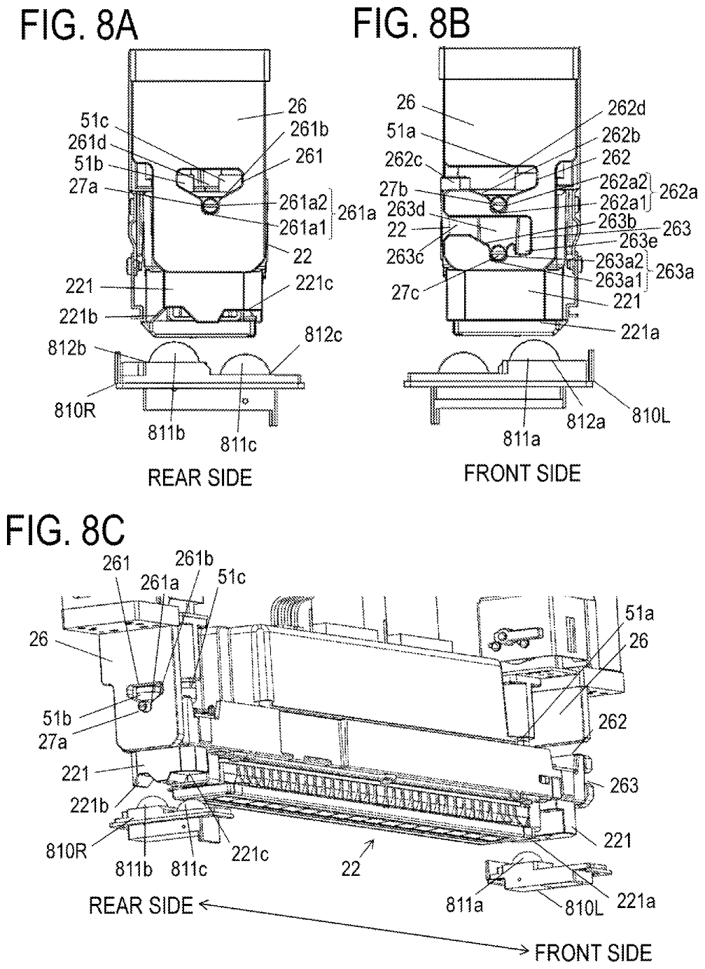

Recording Head Supporting Configuration and Positioning Referring to FIGS. 8A to 8C to FIG. 16, a detailed description will be given of a supporting configuration for the recording head 22 and an example of an operation in the present embodiment.

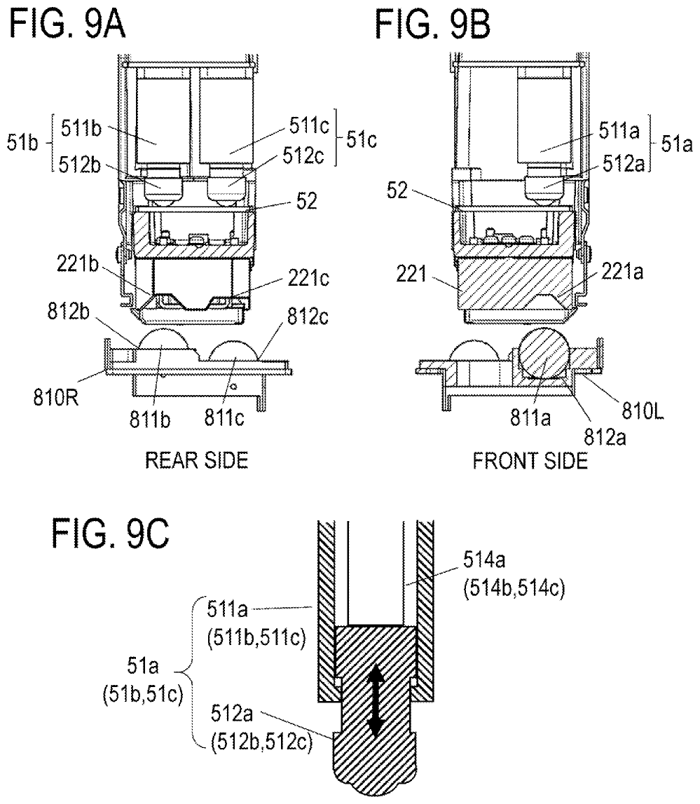

FIGS. 8A to 8C are diagrams illustrating a state of the retracted position to which the recording head 22 has retracted upward. FIG. 8A is the diagram obtained by viewing the recording head 22 and the positioning/supporting portions 810 from the apparatus rear side. FIG. 8B is the diagram obtained by viewing the recording head 22 and the positioning/supporting portions 810 from the apparatus front side. FIG. 8C is a perspective view obtained by viewing the recording head 22 and the positioning/supporting portions 810 from the downstream side in the sheet conveyance direction. FIGS. 9A to 9C are diagrams illustrating relationships between the biasing members 51a, 51b, and 51c and the recording head 22 at the retracted position to which the recording head 22 has retracted upward. FIG. 9A is the diagram obtained by viewing the recording head 22 and the positioning/supporting portions 810 from the apparatus rear side. FIG. 9B is the diagram obtained by viewing the recording head 22 and the positioning/supporting portions 810 from the apparatus from side. FIG. 9C is a schematic cross-sectional view illustrating configurations of the first biasing member 51a, the second biasing member 51b, and the third biasing member 51c.

The head holder 26 is provided with the first hole 261, the second hole 262, and the third hole 263. The first hole 261, the second hole 262, and the third hole 263 are hole portions having respective surfaces facing the first pin 27a, the second pin 27b, and the third pin 27c in directions each perpendicular to the longitudinal direction of the recording head 22. Each of the first hole 261, the second hole 262, and the third hole 263 is configured to have an upper side having a wide open width for the pin and a groove-shaped lower portion which is configured to have a narrow width and into which the pin is to fit.

The first hole 261 has a first groove portion 261a serving as a first supporting portion for supporting the first pin 27a, a first inclined portion 261b for guiding the first pin 27a to the first groove portion 261a, and a first disengagement portion 261d that widens a movable range of the first pin 27a with respect to the first hole 261. The first groove portion 261a includes a supporting surface 261al which is a groove bottom surface and regulating surfaces 261a2 which are a pair of groove side surfaces facing the first pin 27a so as to hold the first pin 27a placed on the supporting surface 261al therebetween on both sides.

The second hole 262 has a second groove portion 262a serving as a second supporting portion for supporting the second pin 27b, a second inclined portion 262b for guiding the second pin 27b to the second groove portion 262a, and a second disengagement portion 262d that widens a movable range of the second pin 27b with respect to the second hole 262. The second groove portion 262a includes a supporting surface 262al which is a groove bottom surface and regulating surfaces 262a2 which are a pair of groove side surfaces facing the second pin 27b so as to hold the second pin 27b placed on the supporting surface 262al therebetween on both sides.

The third hole 263 has a third groove portion 263a serving as a third supporting portion for supporting the third pin 27c, a third inclined portion 263b for guiding the third pin 27c to the third groove portion 263a, and a third disengagement portion 263d that widens a movable range of the third pin 27c with respect to the third hole 263. The third groove portion 263a includes a supporting surface 263al which is a groove bottom surface and regulating surfaces 263a2 which are a pair of groove side surfaces facing the third pin 27c so as to hold the third pin 27c placed on the supporting surface 263al therebetween on both sides.

As a configuration for assembling the recording head 22 to the head holder 26, the first hole 261 is a closed hole, while the second hole 262 and the third hole 263 are holes laterally open in the disengagement portions 262d and 263d. In other words, the second hole 262 is provided with a second notched portion 262c that opens the second hole 262 in a direction perpendicular to the longitudinal direction of the recording head 22 so as to allow the second pin 27b to be introduced into the second hole 262 in the perpendicular direction. Likewise, the third hole 263 is provided with a third notched portion 263c that opens the third hole 263 in a direction substantially perpendicular to the longitudinal direction of the recording head 22 so as to allow the third pin 27c to be introduced into the third hole 263 in the perpendicular direction.

The third hole 263 is further provided with a fourth groove portion 263e to be used to hold the recording head 22 in the inclined attitude so as to facilitate a process of electrically connecting the recording head 22 and the recording apparatus 1 at the time of replacement of the recording head 22.

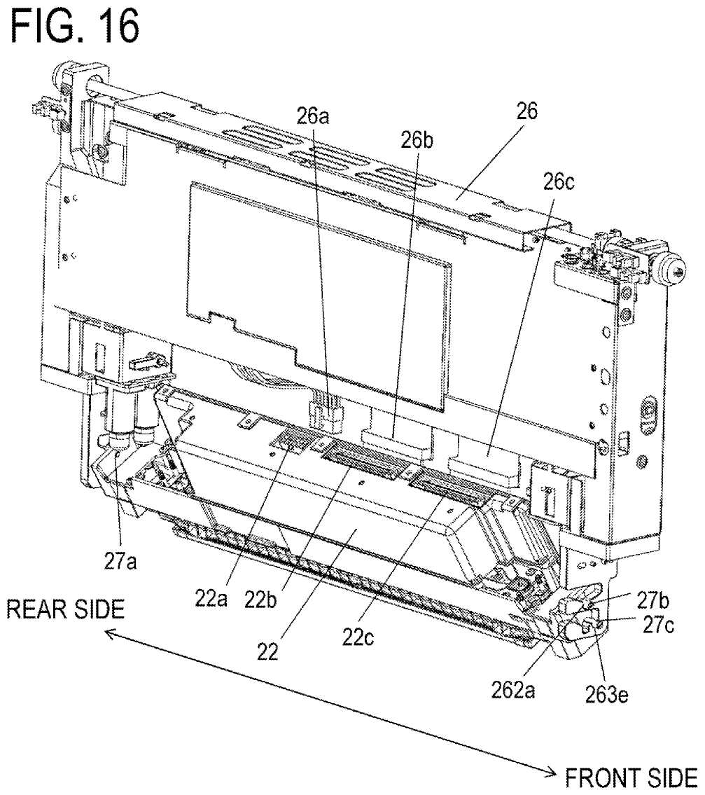

FIG. 16 illustrates a perspective view when the recording head 22 is held inclined. As illustrated in FIG. 16, by setting the third pin 27c of the recording head 22 supported on the head holder 26 in the fourth groove portion 263e, it is possible to hold the recording head 22 inclined. A top surface of the recording head 22 is provided with electric connector connecting portions 22a, 22b, and 22c and, on the head holder 26, electric connectors 26a, 26b, and 26c are placed at positions facing the electric connector connecting portions 22a, 22b, and 22c. As illustrated in FIG. 16, since the recording head 22 can be held inclined, a worker can easily check the electric connector connecting portions 22a, 22b, and 22c provided on the top surface of the recording head 22. In addition, since the electric connector connecting portions 22a, 22b, and 22c are held while being inclined to a worker side and exposed, it is possible to allow a process of easily connecting the electric connectors 26a, 26b, and 26c provided on the recording apparatus 1 side to the electric connector connecting portions 22a, 22b, and 22c of the recording head 22. By providing electric connection portions between the recording head 22 and the recording apparatus 1 on the top surface of the recording head 22, it is possible to reduce a width of the recording head 22 in the longitudinal direction and reduce a width of the entire recording apparatus 1 in the longitudinal direction.

The head holder 26 is provided with the first biasing member 51a, the second biasing member 51b, and the third biasing member 51c each for coming into contact with the recording head 22 to impart a predetermined biasing force.

The first biasing member 51a is placed on a side in a cross direction crossing the up-down direction (advancing-retracting direction) of the recording head 22 or in the sheet conveyance direction which is closer to the first contact portion 221a or the second contact portion 221b than to the third contact portion 221c so as to impart the biasing force to the recording head 22. Preferably, the first biasing member 51a is placed at a position at least partially overlapping the first contact portion 221a when viewed from above the first contact portion 221a, i.e., in the up-down direction of the recording head 22. The second biasing member 51b is placed on a side in a cross direction crossing the up-down direction (advancing-retracting direction) of the recording head 22 or in the sheet conveyance direction which is closer to the first contact portion 221a or the second contact portion 221b than to the third contact portion 221c so as to impart the biasing force to the recording head 22. Preferably, the second biasing member 51b is placed at a position at least partially overlapping the second contact portion 221b when viewed from above the second contact portion 221b, i.e., in the up-down direction of the recording head 22. The third biasing member 51c is placed on a side in a cross direction crossing the up-down direction (advancing-retracting direction) of the recording head 22 or in the sheet conveyance direction which is closer to the third contact portion 221c than to the first contact portion 221a or the second contact portion 221b so as to impart the biasing force to the recording head 22. Preferably, the third biasing member 51c is placed at a position at least partially overlapping the third contact portion 221c when viewed from above the third contact portion 221c, i.e., in the up-down direction of the recording head 22.

As illustrated in FIGS. 9A to 9C, the biasing members 51a, 51b, and 51c are configured to include base portions 511a, 511b, and 511c, sliding portions 512a, 512b, and 512c, and compression springs 514a, 514b, and 514c. The sliding portions 512a, 512b, and 512c are configured to be able to advance and retract with respect to the base portions 511a, 511b, and 511c in a direction in which the recording head 22 is biased.

As illustrated in FIG. 9C, the base portions 511 (511a, 511b, and 511c) are substantially cylindrical members, and the sliding portions 512 (sliding portions 512a, 512b, and 512c) are partially inserted through the insides thereof. The sliding portions 512 are configured such that leading end portions exposed from the base portions 511 come into contact with a plate 52 provided on the recording head 22, while rear end portions inserted through the insides of insertion holes of the base portions 511 receive biasing forces from the compression springs 514 (514a, 514b, and 514c). The compression springs 514 are assembled to back sides of the sliding portions 512 in the insertion holes of the base portions 511 to press rear ends of the sliding portions 512 so as to move the sliding portions 512 from the back sides of the insertion holes toward outlet ports along the up-down direction of the recording head 22. Portions of the sliding portions 512 to be inserted through the insides of the insertion holes of the base portions 511 are provided with engaged portions projecting in directions crossing insertion directions, and opening portions of the insertion holes of the base portions 511 are provided with inward flange portions for retaining the sliding portions 512. Through contact and engagement between the engaged portions and the flange portions, movable ranges of the sliding portions 512 with respect to the base portions 511 in the direction in which the recording head 22 is biased are defined.

Of the foregoing leading end portions of the sliding portions 512, portions that come into contact with the plate 52 are configured of protruded shape portions having partial spherical surfaces. The plate 52 with which the leading end portions of the sliding portions 512 come into contact is at an angle that changes with respect to the advancing-retracting direction of the sliding portions 512 along with an attitude change of the recording head 22. Due to the configuration having the protruded shape described above, when the angle of the plate 52 changes, the sliding portions 512 slide with respect to the plate 52, while advancing or retracting with respect to the base portions 511, to change contact positions and thereby allow a state where the recording head 22 is biased to be maintained. Note that shapes of the leading end portions of the sliding portions 512 are not limited to protruded partial spherical shapes as described above, and any configuration having another shape may be used appropriately as long as the configuration allows the sliding portions 512 to slide, while maintaining the biased state.

As illustrated in FIGS. 8A to 8C, at the retracted position, the recording head 22 has the first pin 27a, the second pin 27b, and the third pin 27c respectively supported by the first groove portion 261a, the second groove portion 262a, and the third groove portion 263a of the head holder 26. The recording head 22 is further supported, while being biased with respect to the head holder 26 under the biasing forces of the first biasing member 51a, the second biasing member 51b, and the third biasing member 51c received by the plate 52. The pins 27a to 27c are pressed against the supporting surfaces 261al to 263al that are the groove bottom surfaces of the groove portions 261a to 263a under the biasing forces of the biasing members 51a, 51b, and 51c. In addition, the pairs of regulating surfaces 261a2 to 263a2 face the pins 27a to 27c pressed against the regulating surfaces 261al to 263al in cross directions crossing the advancing-retracting direction of the recording head 22 to be able to come into contact therewith, and regulate movement of the pins 27a to 27c in the cross direction. Moreover, an engagement portion between the second pin 27b and the second groove portion 262a and an engagement portion between the third pin 27c and the third groove portion 263a are located to be displaced from each other in the advancing-retracting direction of the recording head 22. Consequently, the recording head 22 is in a state (first state) where the recording head 22 is held by the head holder 26 with an angle change that changes an orientation of the ejection surface, i.e., relative rotation with respect to the head holder 26 being regulated. This mode in which the recording head 22 is supported by the head holder 26 corresponds to a first aspect of the present invention.

In the present embodiment, the biasing force of the third biasing member 51c is set larger than each of the biasing forces of the first biasing member 51a and the second biasing member 51b. This is because, in the present embodiment, the recording head 22 illustrated in FIGS. 8A to 8C to FIGS. 15A to 15C has an inclined attitude at the recording position such that a downstream side of the recording head 22 in the sheet conveyance direction is located below an upstream side thereof. The inclined attitude causes a side of the recording head 22 on which the first contact portion 221a and the second contact portion 221b are placed in the sheet conveyance direction to be located below a side thereof on which the third contact portion 221c is placed. Therefore, the biasing force of the third biasing member 51c that biases the upstream side of the recording head 22 in the sheet conveyance direction on which the third contact portion 221c is placed is set larger than the biasing forces of the first and second biasing members 51a and 51b that bias the downstream side thereof on which the first and second contact portions 221a and 221b are placed. Thus, it is possible to stably form a level difference between the first and second positioning members 811a and 811b with which the first and second contact portions 221a and 221b come into contact and the third positioning member 811c with which the third contact portion 221c comes into contact as well as the inclined attitude described above.

The third biasing member 51c that biases the side of the recording head 22 to be located relatively lower corresponds herein to a second biasing member of the present invention, and the biasing force thereof corresponds herein to a second biasing force. Meanwhile, the first biasing member 51a and the second biasing member 51b that bias the side of the recording head 22 to be located relatively higher correspond to a first biasing member of the present invention, and the biasing forces thereof correspond to a first biasing force. As a result, when the inclined attitude of the recording head 22 is different from that illustrated in FIGS. 8A to 8C to FIGS. 15A to 15C, the setting of magnitudes of the biasing forces may also be different, and the correspondence relationship between the first biasing member and the second biasing member of the present invention may also be different. For example, when an attitude that locates the upstream side in the sheet conveyance direction below the downstream side is taken, the first biasing member 51a and the second biasing member 51b correspond to the second biasing member of the present invention, while the third biasing member 51c corresponds to the first biasing member of the present invention. In a case where the recording head 22 is positioned at the recording position without being inclined with respect to the advancing-retracting direction (up-down direction) of the recording head 22, the biasing forces may also be set to have no difference therebetween. Note that the setting of the biasing forces also change depending on a combination thereof with the setting of the level difference between the first and second positioning members 811a and 811b and the third positioning member 811c, and various settings are possible. In other words, the biasing forces can optionally be set appropriately as long as an intended inclination can stably be formed.

In addition, the present invention is not limited to a configuration that imparts biasing forces as described above and, when a weight of the recording head 22 is sufficiently large, the biasing forces of the first biasing member 51a, the second biasing member 51b, and the third biasing member 51c need not be imparted. In the present embodiment, it is assumed that a diameter of the first pin 27a is 5.90 to 6.00 mm and a width of the first groove portion 261a is 6.00 to 6.10 mm, but no problem arises as long as a dimension difference between the diameter of the pin and the width of the groove is not more than about 1 mm. The same applies also to the second pin 27b and the second groove portion 262a and to the third pin 27c and the third groove portion 263a. As a result of supporting of the first pin 27a, the second pin 27b, and the third pin 27c each provided on the recording head 22 by the first groove portion 261a, the second groove portion 262a, and the third groove portion 263a provided in the head holder 26, two of the three pins serve as references, and the remaining one pin serves as a rotation stopper. Consequently, the recording head 22 at the retracted position is supported in a stable attitude by the head holder 26. In the present embodiment, the first pin 27a and the second pin 27b are provided at substantially the same height, but may also be provided at different heights.

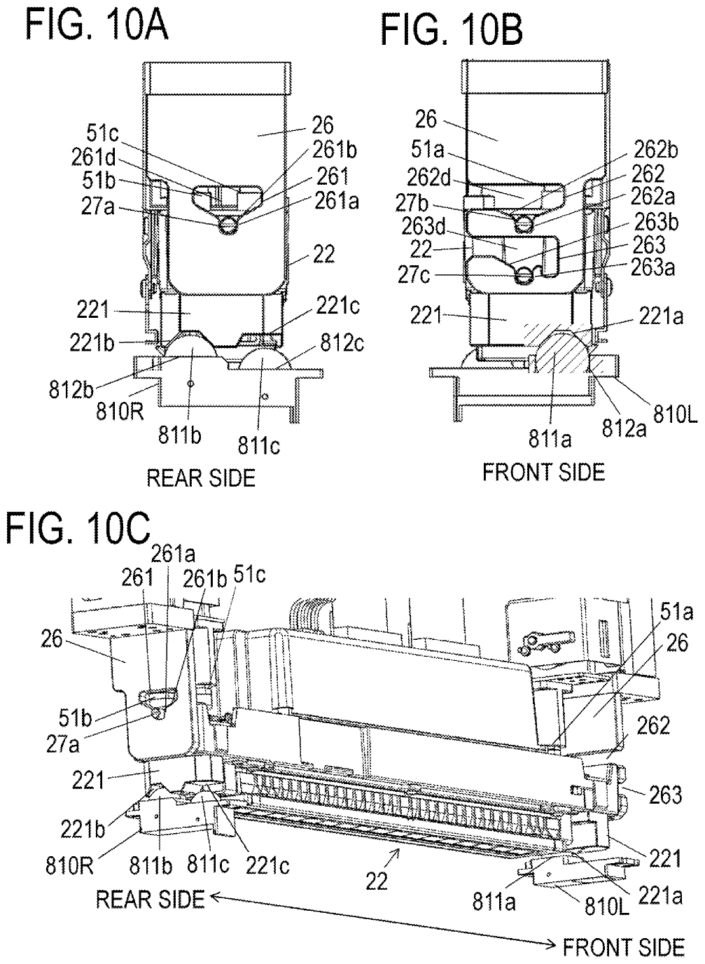

FIGS. 10A to 10C are diagrams illustrating a condition when the head holder 26 supporting the recording head 22 has lowered from the retracted position toward the printing position, and some of the contact portions of the recording head 22 have come into contact with some of the positioning members. Specifically, the first contact portion 221a of the recording head 22 is in contact with the first positioning member 811a, and the second contact portion 221b is in contact with the second positioning member 811b. In the advancing-retracting direction of the recording head 22, the third positioning member 811c is placed at a position lower than that of each of the first positioning member 811a and the second positioning member 811b, and consequently the third contact portion 221c is not in contact with the third positioning member 811c. FIG. 10A is a diagram obtained by viewing the head holder 26 and the recording head 22 from the apparatus rear side, FIG. 10B is a diagram obtained by viewing the recording head 22 and the head holder 26 from the apparatus front side, and FIG. 10C is a perspective view obtained by viewing the recording head 22 and the head holder 26 from the downstream side in the sheet conveyance direction.

At this time, a state is maintained where the first pin 27a, the second pin 27b, and the third pin 27c of the recording head 22 are supported respectively by the first groove portion 261a, the second groove portion 262a, and the third groove portion 263a of the head holder 26. In other words, the recording head 22 is supported by the head holder 26 in a first supporting mode in which the angle change that changes the orientation of the ejection surface is regulated.

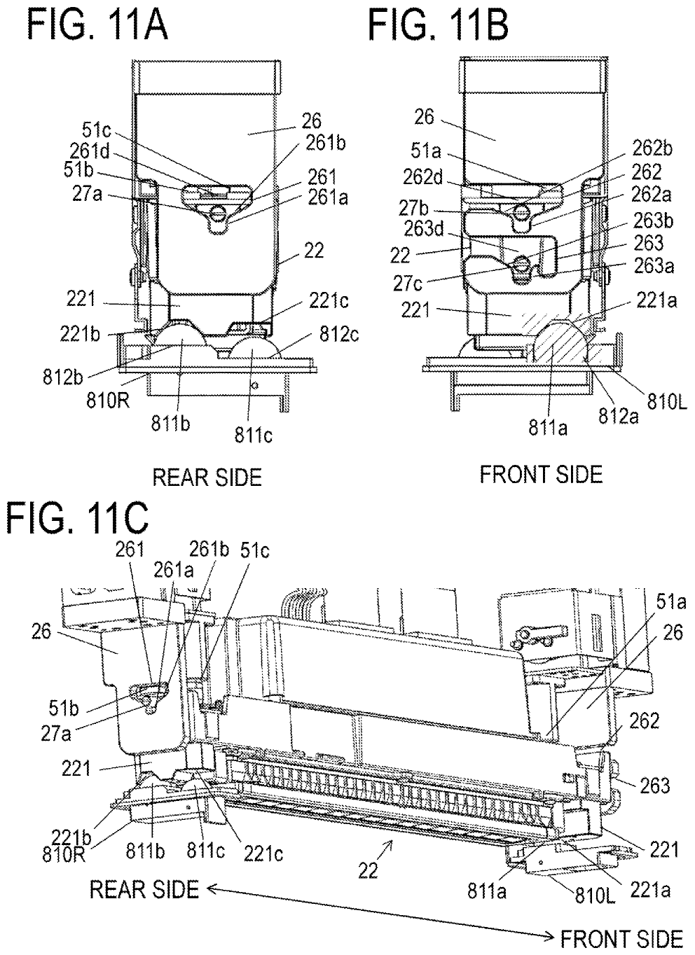

FIGS. 11A to 11C are diagrams illustrating a state where the head holder 26 has further lowered from the state in FIGS. 10A to 10C toward the printing position. FIG. 11A is the diagram obtained by viewing the head holder 26 from the apparatus rear side, FIG. 11B is the diagram obtained by viewing the head holder 26 from the apparatus front side, and FIG. 11C is a perspective view obtained by viewing the head holder 26 from the downstream side in the sheet conveyance direction. FIGS. 11A to 11C illustrate a condition in which, due to generation of forces against the biasing forces of the biasing members 51a to 51c in some of contact portions previously in contact with the positioning members, the recording head 22 has moved relative to the head holder 26 in a direction opposite to a lowering direction. The biasing forces of the biasing members 51a to 51c act in a first direction in which the recording head 22 moves from the retracted position to the printing position with respect to the head holder 26. The recording head 22 receives a force acting in a direction against the foregoing biasing forces from the first positioning member 811a at the first contact portion 221a, and similarly receives a force acting in the direction against the foregoing biasing forces from the third positioning member 811c at the third contact portion 221c. Under the action of the reaction forces, the pins 27a to 27c are guided respectively by the groove side surfaces (regulating surfaces) of the groove portions 261a to 263a, and the recording head 22 moves relative to the head holder 26 in a second direction opposite to the first direction. As a result, as illustrated in FIGS. 11A to 11C, the first pin 27a, the second pin 27b, and the third pin 27c of the recording head 22 move away from the first groove portion 261a, the second groove portion 262a, and the third groove portion 263a of the head holder 26.

When further lowering from the state illustrated in FIGS. 10A to 10C toward the printing position to move to the state illustrated in FIGS. 11A to 11C, the recording head 22 retains a substantially horizontal state. This is because the first pin 27a, the second pin 27b, and the third pin 27c of the recording head 22 are positioned or stopped from rotating with respect to the first groove portion 261a, the second groove portion 262a, and the third groove portion 263a of the head holder 26 in the sheet conveyance direction. When the state illustrated in FIGS. 10A to 10C changes to the state illustrated in FIGS. 11A to 11C, the pins 27a to 27c come off from the groove portions 261a to 263a to move to the disengagement portions 261d to 263d having enlarged movable ranges in the holes 261 to 263. In this state, the pins 27a to 27c are movable relative to the holes 261 to 263 over wide ranges, the angle change of the ejection port surface of the recording head 22 with respect to the head holder 26 is not regulated, and the recording head 22 is supported by the head holder 26 in the state (second state) where the angle of the ejection port surface is variable and relative movement is possible. This supporting mode corresponds to a second aspect of the present invention.

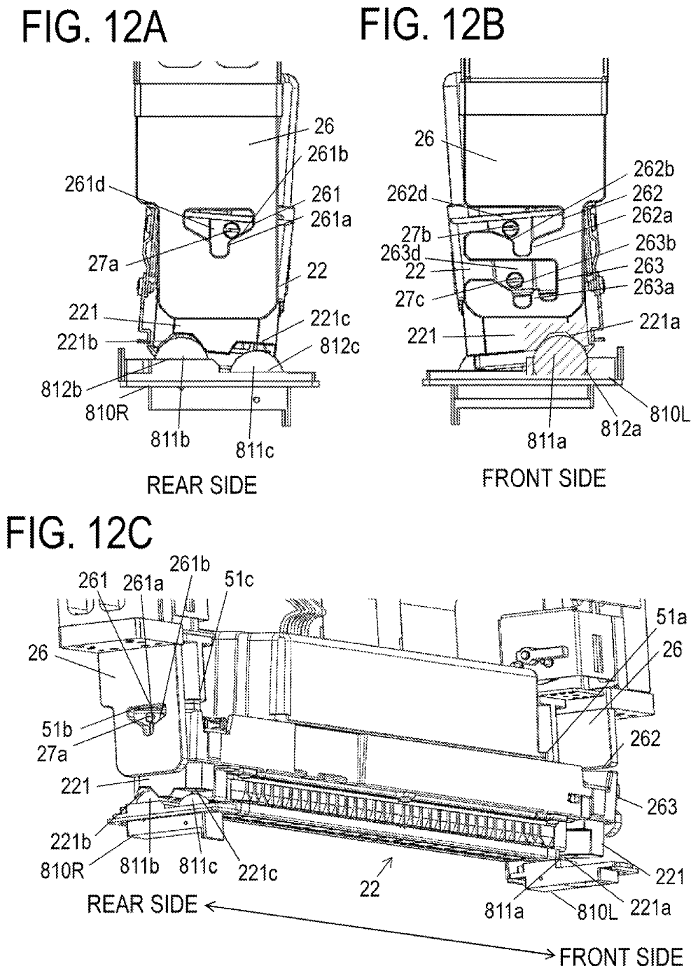

FIGS. 12A to 12C are diagrams when the head holder 26 has further lowered from the state in FIGS. 11A to 11C toward the printing position. FIG. 12A is the diagram obtained by viewing the head holder 26 from the apparatus rear side, FIG. 12B is the diagram obtained by viewing the head holder 26 from the apparatus front side, and FIG. 12C is a perspective view obtained by viewing the head holder 26 from the downstream side in the sheet conveyance direction.

As illustrated in FIGS. 11A to 11C, a state is provided where the pins 27a, 27b, and 27c of the recording head 22 are away from the groove portions 261a, 262a, and 263a of the head holder 26 and have wider movable ranges with respect to the holes 261, 262, and 263. Consequently, when the recording head 22 further lowers the head holder 26 toward the printing position, forces exerted from the positioning members on the contact portions, the biasing forces exerted from the biasing members on the plate 52, and the like are balanced to allow the recording head 22 to make the attitude change that changes the angle of the ejection port surface. Specifically, the recording head 22 is rotatable with respect to the head holder 26 by using the straight line passing through the center of the first positioning member 811a and the center of the second positioning member 811b as the rotation axis. The biasing force of the third biasing member 51c is set larger than the biasing forces of the first biasing member 51a and the second biasing member 51b. As a result, a force to rotate the recording head 22 acts in a direction in which the third contact portion 221c comes into contact with the third positioning member 811c, while the pins 27a, 27b, 27c move further away from the groove portions 261a, 262a, and 263a.

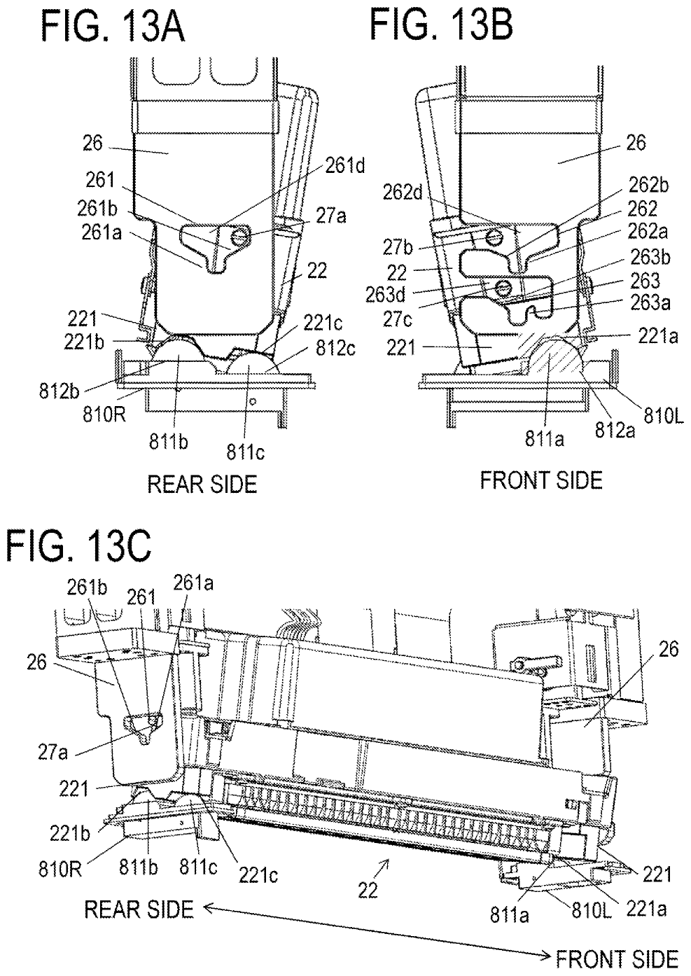

FIGS. 13A to 13C are diagrams illustrating a state (printing position) where positioning between the recording head 22 and the positioning/supporting portions 810 of the sheet conveyance portion housing 81 is completed. FIG. 13A is the diagram obtained by viewing the recording head 22 and the positioning/supporting portions 810 from the apparatus rear side, FIG. 13B is the diagram obtained by viewing the recording head 22 and the positioning/supporting portions 810 from the apparatus front side, and FIG. 13C is a perspective view obtained by viewing the recording head 22 and the positioning/supporting portions 810 from the downstream side in the sheet conveyance direction.

As a result of further lowering of the head holder 26 from the state illustrated in FIGS. 12A to 12C, the recording head 22 continues to rotate around the foregoing rotation axis, and the third contact portion 221c comes into contact with the third positioning member 811c. The sliding portions 512a, 512b, and 512c are configured herein to be slidable so as to change the contact positions with respect to the plate 52, while changing amounts of projection from the base portions 511a, 511b, and 511c. Therefore, each of the biasing members 51a, 51b, and 51c can bias the recording head 22 with respect to the positioning member 811, while following movement of the plate 52 resulting from the angle change of the recording head 22.

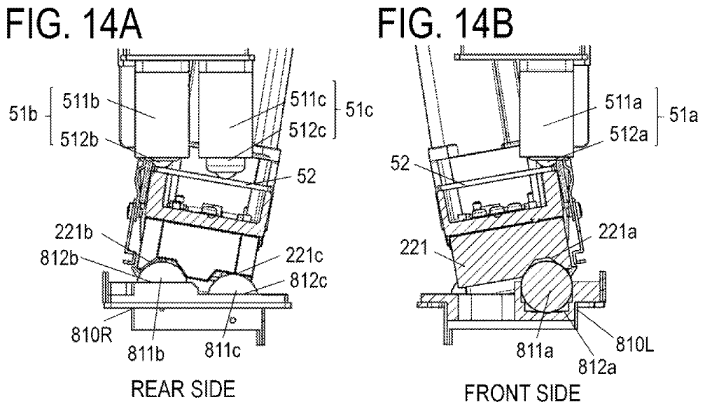

FIGS. 14A and 14B are diagrams illustrating conditions of the recording head 22 and the biasing members 51a, 51b, and 51c in the state illustrated in FIGS. 13A to 13C, of which FIG. 14A is the diagram obtained by viewing the recording head 22 and the biasing members 51a, 51b, and 51c from the apparatus rear side and FIG. 14B is the diagram obtained by viewing the recording head 22 and the biasing members 51a, 51b, and 51c from the apparatus front side. At this time, in a state where the to-be-positioned portions 221 are pressed against the positioning members 811 under the biasing forces of the biasing members 51 provided on the head holder 26, the recording head 22 is balanced in an attitude inclined with respect to the head holder 26. In other words, in the attitude at this time, the recording head 22 is positioned with respect to the head holder 26. In addition, a state is established where the first pin 27a, the second pin 27b, and the third pin 27c are disengaged from the first groove portion 261a, the second groove portion 262a, and the third groove portion 263a. Thus, a state is eventually reached where the recording head 22 completely follows the positioning members 811a, 811b, and 811c having a predetermined level difference therebetween, and therefore the recording head 22 can be positioned with high accuracy in the attitude inclined at the predetermined angle at the printing position.

Note that, depending on the positioning angle of the recording head 22 at the printing position, the biasing forces from the biasing members 51a, 51b, and 51c are not necessarily indispensable, and the recording head 22 may also be configured to be biased and positioned only under a weight thereof.

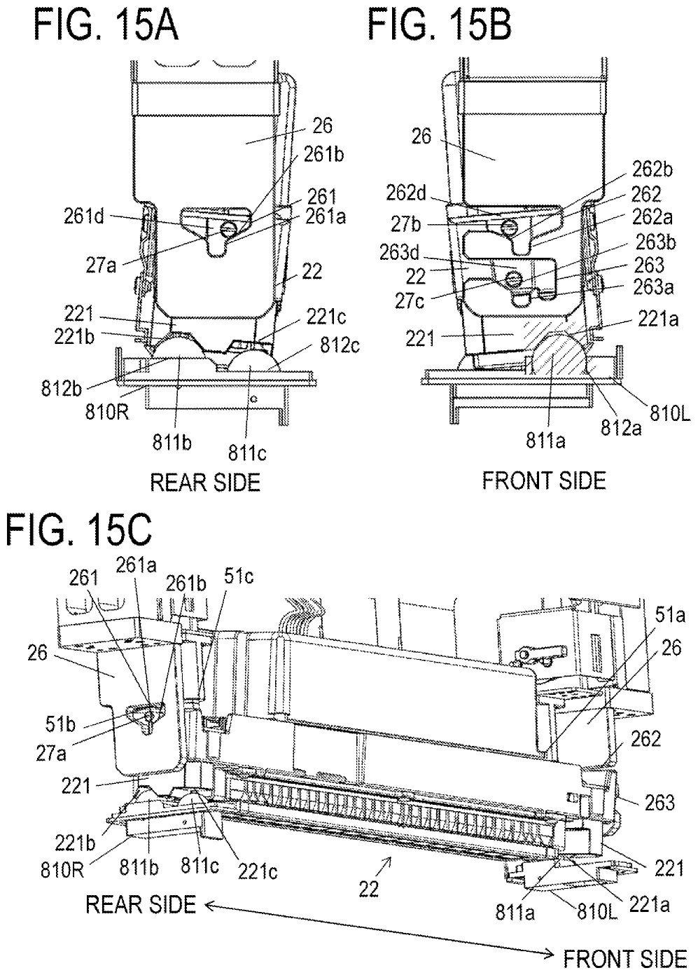

FIGS. 15A to 15C are illustrative views when the head holder 26 has risen from the printing position to start retracting the recording head 22 upward. FIG. 15A is the view obtained by viewing the head holder 26 and the recording head 22 from the apparatus rear side. FIG. 15B is the view obtained by viewing the head holder 26 and the recording head 22 from the apparatus front side. FIG. 15C is the perspective view obtained by viewing the head holder 26 and the recording head 22 from the downstream side in the sheet conveyance direction. As illustrated in FIGS. 13A to 13C, at the printing position, the recording head 22 is positioned in the attitude inclined at the predetermined angle. Accordingly, the first pin 27a and the first groove portion 261a, the second pin 27b and the second groove portion 262a, and the third pin 27c and the third groove portion 263a are displaced from each other in the sheet conveyance direction. As a result, when the recording head 22 is elevated as a result of rising of the head holder 26, any or all of the first pin 27a and the first groove portion 261a, the second pin 27b and the second groove portion 262a, and the third pin 27c and the third groove portion 263a are brought into contact with each other to result in such a state as in FIGS. 15A to 15C. When the head holder 26 further rises from such a state, the first pin 27a is guided to the first inclined portion 261b under either or both of the biasing forces of the biasing members 51a, 51b, and 51c and the weight of the recording head 22 to enter the first groove portion 261a. The same applies also to the second pin 27b and the third pin 27c. In other words, the mode in which the recording head 22 is supported by the head holder 26 changes from the second mode in which the rotation of the recording head 22 that changes the angle of the ejection port surface is allowed to the first mode in which the foregoing rotation of the recording head 22 is regulated. This allows the recording head 22 to move in a stable attitude in which the rotation with respect to the head holder 26 is regulated from the printing position to the retracted position.

According to the present embodiment, it is possible to implement a highly versatile guide mechanism capable of positioning the recording head 22 at any angle. In other words, movement of the head holder 26 holding the recording head 22 has a simple movement configuration in which a direction of movement thereof is only a linear direction. Then, the recording head 22 comes into contact with the positioning members 811 to change the mode in which the recording head 22 is supported by the head holder 26 from the first mode in which the rotation of the recording head 22 is regulated to the second mode in which the rotation is allowed. This configuration is implemented by devising a configuration of engagement between the pins 27 of the recording head 22 and the holes 261 to 263 of the head holder 26. In other words, a configuration is provided such that the holes 261 to 263 have the groove portions 261a to 263a that regulate lateral movement of the pins 27 crossing the movement direction of the head holder 26 and the disengagement portions 261d to 263d that allow the lateral movement of the pins 27 in predetermined ranges. By providing a configuration such that the recording head 22 moves relative to the head holder 26 as a result of contact with the positioning members 811 to move positions where the pins 27 are engaged with the holes 261 to 263, the foregoing change of the supporting mode is allowed.

According to the present embodiment, it is possible to appropriately set the magnitude of the inclination of the recording head when the recording head is positioned at the recording position by producing a difference between the timings of contact between the plurality of contact portions and the plurality of corresponding positioning portions. Specifically, the difference is a difference between first contact timing for a first contact portion (contact portions 221a and 221b) and the first positioning portion (positioning members 811a and 811b) and second contact timing for a second contact portion (contact portion 221c) and the second positioning portion (positioning member 811c). By appropriately setting the timing difference correspondingly to the intended positioning angle of the recording head, it is possible to incline the recording head at the intended angle.

In this embodiment, the configuration is provided in which, by producing a difference between a first contact position where the first contact portion and the first positioning portion come into contact with each other and a second contact position where the second contact portion and the second positioning portion come into contact with each other in the up-down direction of the recording head, the foregoing contact timing difference is produced. More specifically, in the present embodiment, a level difference in the up-down direction of the recording head is produced between the first positioning portion and the second positioning portion to produce the difference between the contact positions.

A configuration that produces the difference between the contact timings is not limited to the configuration described in the present embodiment. The configuration may also be such that, e.g., no level difference is produced between the first positioning portion and the second positioning portion, but a level difference in the foregoing up-down direction is produced between the first contact portion and the second contact portion to produce the difference between the contact timings. Alternatively, the configuration may also be such that a level difference is produced between the first positioning portion and the second positioning portion, and a level difference is also produced between the first contact portion and the second contact portion.

In addition, in the present embodiment, the configuration is such that the spherical bodies of equal diameters are used as the positioning members 811 and fitted into the depressed portions 812 of the positioning/supporting portions 810 to form the positioning portions. Such a configuration allows the configuration in which a height difference is produced between the plurality of depressed portions 812 to produce a difference between the contact timings described above to be easily implemented. In other words, the forms of the depressed portions 812 of the positioning/supporting portions 810 need only to be set different according to specifications of the individual recording heads 22, while other member configurations can be shared, and therefore it is possible to implement a highly versatile guide mechanism.

However, the configuration of each of the positioning portions is not limited to the configuration in the present embodiment. For example, the configuration may also be such that no height difference is produced between the plurality of depressed portions 812, but shapes and sizes of the positioning members are set different to produce a difference between the contact timings. In addition, the shape of each of the positioning members is not limited to a spherical body, and a form of the positioning member may also have, e.g., a partial spherical surface at least in a region in contact with the contact portion. The configuration may also be such that the positioning members 811 and the positioning/supporting portions 810 are integrally molded.

In addition, in the present embodiment, a positioning/contact configuration is such that the contact portions have the depressed shapes, the positioning portions have the protruded shapes, and positioning is performed through uneven engagement therebetween, but the configuration is not limited to such a configuration. For example, it may also be possible that the contact portions have protruded shapes and the positioning portions have depressed shapes, or the contact portions and the positioning portions may be combined such that some of the plurality of contact portions have depressed shapes and others thereof have projected shapes and, in correspondence thereto, some of the positioning portions have protruded shapes and others thereof have depressed shapes.

In addition, a specific depressed shape of each of the contact portions, i.e., a combination of a cone and a groove may also have a layout different from that in the present embodiment. In the present embodiment, the contact portion 221b serving as the first contact portion provided on the same side as that of the contact portion 221c serving as the second contact portion in the sheet width direction (recording head longitudinal direction) is formed as the groove-shaped portion, while the contact portion 221a serving as the first contact portion provided on the opposite side is formed as the depressed conical portion. However, it may also be possible to change the contact portion 221a from the depressed conical portion to the groove-shaped portion and change the contact portion 221b from the groove-shaped portion to the depressed conical portion.

Note that, in the present embodiment, the configuration is such that a side on which the contact portion 221a having the conical shape serves as a reference point side during a recording operation of the recording head 22, and the side provided with the conical portion and a sheet conveyance reference side in the sheet width direction are on the same side. In other words, the positioning configuration on an operation reference point side of the recording head 22 is provided as a configuration in which the contact portion 221a made of the conical depressed portion and the positioning member 811a made of the partially spherical protruded portion are engaged with each other, and mutual positional regulation is performed in the sheet conveyance direction and the sheet width direction. Meanwhile, the positioning configuration on the side opposite to the operation reference side of the recording head 22 is made of the groove-shaped contact portions 221b and 221c which are open in the sheet width direction to absorb an effect of a dimension error or the like (eliminate a dimension error). Thus, it is preferable to provide the reference point for the recording head 22 and a sheet conveyance reference on the same side, and variations in a position of an image formed on the sheet can be reduced. In addition, by keeping the conical portion serving as the reference point for the recording head 22 as far as possible from an apparatus heat source, a configuration immune to the influence of thermal deformation is provided. In the present embodiment, the configuration is such that a position where the conical portion is provided is provided not on the apparatus rear side having a large number of heat sources such as an electric substrate, but on the apparatus front side.

In the present embodiment, the contact portion 221c serving as the second contact portion is placed on the same side (apparatus rear side) as that of the contact portion 221b in the longitudinal direction (width direction) of the recording head 22, but may also be placed on the same side (apparatus front side) as that of the opposite-side contact portion 221a.

In addition, in the present embodiment, the configuration is such that the pair of the first contact portions (contact portions 221a and 221b) are provided on both sides in the longitudinal direction (sheet width direction) of the recording head, while the second contact portion (contact portion 221c) is provided only on one side in the longitudinal direction. In other words, in the present embodiment, the configuration is such that positioning/contact is performed at three points but, for example, a 4-point contact configuration in which two points are provided on each of both sides in the longitudinal direction may also be adopted. However, the 3-point contact configuration allows positioning/supporting to be performed by eliminating displacement due to a member dimension error or the like and allows high-accuracy positioning to be performed by reducing an effect due to a product individual difference.

In other words, a specific configuration of the positioning/contact configuration may optionally be adopted as long as a reference axis of the rotation of the recording head 22 can be parallel to the nozzle plates 223 (ejection port surface).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-095567, filed on Jun. 14, 2022, which is hereby incorporated by reference herein in its entirety.

What is claimed is:

1. A recording apparatus comprising:
a recording head having an ejection port surface in which an ejection port that ejects a liquid is provided; and
a supporting portion configured to support the recording head to move the recording head between a recording position where recording is performed and a non-recording position where the recording is not performed,
wherein the supporting portion can be in a first state where an angle change of the ejection port surface is regulated and a second state where the angle change of the ejection port surface is not regulated.

2. The recording apparatus according to claim 1, further comprising:
a positioning portion configured to position, at a predetermined angle, the recording head at the recording position,
wherein, in a case where the supporting portion is in the first state, the recording head and the positioning portion do not come into contact with each other while, in a case where the supporting portion is in the second state, the recording head and the positioning portion come into contact with each other.

3. The recording apparatus according to claim 2,
wherein the recording head has a supported portion,
wherein the supporting portion has a supporting surface for coming into contact with the supported portion to support the recording head, and
wherein, in the first state, the supporting surface comes into contact with the supported portion while, in the second state, the supporting surface moves away from the supported portion.

4. The recording apparatus according to claim 3,
wherein the supporting portion has a regulating surface that can come into contact with the supported portion in contact with the supporting surface so as to regulate movement of the recording head that changes an angle of the ejection port surface, and
wherein, in the first state, the regulating surface can come into contact with the supported portion while, in the second state, the regulating surface does not come into contact with the supported portion.

5. The recording apparatus according to claim 4,
wherein the supported portion is each of projecting portions projecting from both ends of the recording head in a cross direction crossing a movement direction of the recording head in the cross direction,
wherein the supporting portion has hole portions having surfaces facing the projecting portions in directions perpendicular to the cross direction, and
wherein each of the surfaces of the hole portions includes the supporting surface and the regulating surface.

6. The recording apparatus according to claim 4,
wherein the supporting portion further has a biasing member that biases the recording head such that the supported portion comes into contact with the supporting surface, and
wherein the positioning portion comes into contact with the recording head so as to generate a force against a biasing force of the biasing member.

7. The recording apparatus according to claim 6,
wherein the supporting surface faces the supported portion in a second direction opposite to a first direction which is included in a movement direction of the recording head and in which the recording head moves from the non-recording position to the recording position,
wherein the biasing member biases the recording head in the first direction, and
wherein the positioning portion comes into contact with the recording head in the second direction.

8. The recording apparatus according to claim 1,
wherein a movement direction of the supporting portion is a linear direction.

9. The recording apparatus according to claim 2,
wherein the recording head includes:
a first contact portion; and
a second contact portion provided at a position different from a position of the first contact portion in a cross direction crossing a movement direction of the recording head, and
wherein the positioning portion includes:
a first positioning portion that comes into contact with the first contact portion in a case where the recording head is at the recording position; and
a second positioning portion that comes into contact with the second contact portion in a case where the recording head is at the recording position.

10. The recording apparatus according to claim 9,
wherein an angle of the ejection port surface of the recording head at the recording position is determined by a difference between a first contact position and a second contact position in the movement direction of the recording head, the first contact position is a position where the first contact portion and the first positioning portion come into contact with each other, and the second contact position is a position where the second contact portion and the second positioning portion come into contact with each other.

11. The recording apparatus according to claim 9,
wherein an angle of the ejection port surface of the recording head at the recording position is determined by a difference between first timing and second timing when the recording head moves to the recording position, the first timing is timing at which the first contact portion and the first positioning portion come into contact with each other, and the second timing is timing at which the second contact portion and the second positioning portion come into contact with each other.

12. The recording apparatus according to claim 9,
wherein the first positioning portion and the second positioning portion are at different positions in the movement direction.

13. The recording apparatus according to claim 12,
wherein the second positioning portion is further away from the recording head than the first positioning portion in the movement direction.

14. The recording apparatus according to claim 13,
wherein the recording head has a supported portion,
wherein the supporting portion has a supporting surface for coming into contact with the supported portion to support the recording head,
wherein the supporting portion further has a biasing member that biases the recording head such that the supported portion comes into contact with the supporting surface,
wherein the biasing member includes:
a first biasing member that comes into contact with the recording head on a side closer to the first contact portion than to the second contact portion in the cross direction to impart a first biasing force to the recording head; and
a second biasing member that comes into contact with the recording head on a side closer to the second contact portion than to the first contact portion in the cross direction to impart a second biasing force to the recording head, and
wherein the second biasing force is larger than the first biasing force.

15. The recording apparatus according to claim 9,
wherein either one of the first contact portion and the first positioning portion has a protruded shape, while another of the first contact portion and the first positioning portion has a depressed shape, and
wherein either one of the second contact portion and the second positioning portion has a protruded shape, while another of the second contact portion and the second positioning portion has a depressed shape.

16. The recording apparatus according to claim 15, further comprising:
a conveyance portion that conveys a recording material to a position facing the ejection port surface of the recording head at the recording position,
wherein the first contact portion and the second contact portion are provided at different positions in a conveyance direction of the recording material.

17. The recording apparatus according to claim 16,
wherein an angle of the ejection port surface changes with rotation of the recording head around a rotation axis parallel to a width direction of the recording material perpendicular to the conveyance direction.

18. The recording apparatus according to claim 17,
wherein the protruded shape is a hemispherical shape, and
wherein the depressed shape is a groove shape extending in the width direction of the recording material perpendicular to the conveyance direction or a conical shape.

19. The recording apparatus according to claim 18,
wherein a pair of the first contact portions are provided on both sides of the recording head in the width direction, and
wherein the second contact portion is provided on one side of the recording head in the width direction.

20. The recording apparatus according to claim 19,
wherein each of the first positioning portion and the second positioning portion has the hemispherical shape,
wherein the second contact portion has the groove shape,
wherein, of the pair of first contact portions, the first contact portion provided on the same side as that of the second contact portion in the width direction has the groove shape, and
wherein, of the pair of first contact portions, the first contact portion provided on the side opposite to that of the second contact portion in the width direction has the conical shape.
